(19) United States
(12) Patent Application Publication
(10) Pub. No.: US 2011/0272055 A1
(43) Pub. Date: Nov. 10, 2011

(54) Device and method for transferring air from a first tire to second tire

(76) Inventor: Maria C. Lepera, Huntington, NY (US)

(21) Appl. No.: 12/799,992

(22) Filed: May 6, 2010

(51) Int. Cl. B65B 1/04; B60C 23/00

(52) U.S. Cl. 141/1; 152/415

(57) ABSTRACT

A device and method for transferring air from a first tire to a second tire which comprises an elongated flexible tube having an air flow passageway therethrough. Two coupling adaptor components are provided, with each attached to a free end of the elongated flexible tube to engage with an air valve of one of the tires. A mechanism in each of the coupling adaptor components is for opening the air valves in one of the tires, to allow air to transfer from the second tire to the first tire that is under inflated, to balance some of the air pressure between the tires.

### BACKGROUND OF THE INVENTION

1. Field of the Invention

The present invention relates to a tire inflation apparatus, and more particularly, a device and method for transferring air from a first tire to a second tire.

2. Description of the Prior Art

Numerous innovations for tire inflating apparatuses have been provided in the prior art that will be described. Even though these innovations may be suitable for the specific individual purposes to which they address, however, they differ from the present invention.

A FIRST EXAMPLE, U.S. Pat. No. 2,976,906, Issued on Mar. 28, 1961, to Kamm et al. teaches a tire pressure control system for a vehicle mounting an axle and a wheel hub rotatable thereon; a conduit formed in the axle terminating in an orifice formed in the surface thereof, sealing structure contained within a recess of the wheel hub, the sealing structure including a set of annular sealing rings encompassing the axle and axially positioned on both sides of the orifice, lips formed on the sealing rings projecting toward the orifice, holding rings positioning the sealing structure within the recess, a coupling within the wheel supporting flange of the hub and a conduit connecting the coupling with the recess whereby compressed gas may flow through the axle to the coupling.

A SECOND EXAMPLE, U.S. Pat. No. 3,705,614, Issued on Dec. 12, 1972, to Juttner et al. teaches a vehicle wheel having air tires to be connected with an air filling device of the vehicle, which comprises a rotating air passage ring disposed centrally to an axle; a tire filling valve is connected with the ring by means of conduits; a wheel hub receives the air passage ring; a guide face of a bearing neck of the axle and of a hub carrier is provided, and an air passage ring is sealingly slidingly mounted on the guide face.

A THIRD EXAMPLE, U.S. Pat. No. 3,760,859, Issued on Sep. 25, 1973, to Shahan et al. teaches a device for equalizing the pressure in the pneumatic tires of a dual wheel assembly that employs a valve shuttle which has three positions: (a) it isolates pressure in one tire, (b) it equalizes the pressure between the tires, (c) it isolates pressure in the other tire. A fill valve assembly has an element for holding the valve shuttle in position (b) so that the tire pressures are equalized during filling. Also, the valve shuttle closes by pressure differential in the case of a blowout or puncture of one of the tires, to prevent loss of pressure from the other tire. Furthermore, a pressure relief valve is provided to prevent overpressure in either of the tires.

A FOURTH EXAMPLE, U.S. Pat. No. 4,037,638, Issued on Jul. 26, 1977, to Mosca teaches an emergency kit for simultaneously equalizing the inflation pressure in the four tires of a motor vehicle and in the spare tire thereof. Four lengths of flexible tubing are interconnected by tee couplings. One end of three of such lengths of tubing is given a coupling for connection with the inflation valve of a tire whereas the other length of coupling has such a coupling at each end. A foot operable diaphragm pump is connected in one length of tubing.

A FIFTH EXAMPLE, U.S. Pat. No. 4,742,857, Issued on May 10, 1988, to Gandhi teaches a system for detecting the air pressure in each wheel and for effecting inflation or deflation in each wheel while the vehicle is operating including a controller and a high pressure reservoir mounted on each wheel. Each controller includes a magnet that is positioned responsive to the pressure in the associated tire and a stationarily mounted solenoid detector senses the position of the magnet and generates a signal which is fed to a data processor for the generation of an output signal to the vehicle operator indicating the pressure in the tire. Additionally, through actuation of the control, a current is passed through a coil on the solenoid detector to actuate the magnet in an individual wheel for opening a valve and allowing air to flow through the tube into the tire for raising the tire pressure, or to allow the exhaust of air to lower the tire pressure.

A SIXTH EXAMPLE, U.S. Pat. No. 5,121,780, Issued on Jun. 16, 1992, to Goodman teaches a flexible air valve extension for filling an inaccessible vehicle spare tire includes an elongated flexible tube having a rigid elbow portion at one end which terminates in an internally threaded fitting dimensioned for engagement with a conventional tire valve. An externally threaded valve body at an opposite end of the flexible tube is received through a transverse flange of a mounting bracket. A pair of lock nuts are in threaded engagement with the valve body on opposite sides of the flange and secure the valve body to the bracket. The valve body includes a spring biased valve dimensioned for cooperation with conventional automotive pressure gages and air lines. The bracket is dimensioned for securement on an accessible portion of a vehicle, such as the frame of a spare tire carrier.

A SEVENTH EXAMPLE, U.S. Pat. No. 5,307,846, Issued on May 3, 1994, to Heinemann teaches an apparatus which provides individual vehicle motorists with a simple, low-cost way to adjust and balance the pressure within their individual vehicle's tires without accidentally exceeding the maximum pressure level of the tires. The apparatus, interconnects the four tires with itself, and a pressure gauge and a conventional tire air-valve permits the internal air pressure of all four tires to be adjusted uniformly from one air source through a unique low cost combination of a commercial connector and a specially designed shut-off valve and to be disconnected without a loss of air in any of the four tires. If a pre-set air pressure level has been exceeded while air is being pumped into the tires, a safety air pressure-relief valve, coupled to a whistle, is triggered, notifying the motorist of this condition.

AN EIGHTH EXAMPLE, U.S. Patent Office Document No. D361,950, Issued on Sep. 5, 1995, to Mascio teaches an ornamental design for a tire air pressure equalizer, as shown an described.

A NINTH EXAMPLE, U.S. Pat. No. 5,472,032, Issued on Dec. 5, 1995, to Winston et al. teaches a gas transfer system for establishing or maintaining a predetermined gas pressure within a plenum, such as a tire. In an exemplary embodiment, the gas transfer system includes a power source, a pressure sensor, a control unit, and a gas transfer mechanism. Preferably, a gas transfer mechanism includes a micromechanical device, comprising one or more pumping units that transfer gas from one pressure zone to another. In one embodiment, pumping is accomplished, in part, by heating the gas within a sealable chamber of a pumping unit to cause the pressure of the gas to increase. In another embodiment, the change in pressure of the gas caused by compression of a tire provides a pumping force. Valves are provided for regulating movement of the gas through the gas transfer mechanism and can include electromechanical valves responsive to signals from the control unit, or passively biased valves responsive to applied gas pressure.

It is apparent now that numerous innovations for tire inflating apparatuses have been provided in the prior art that adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a device and method for transferring air from a first tire to a second tire that avoids the disadvantages of the prior art.

ANOTHER OBJECT of the present invention is to provide a device and method for transferring air from a first tire to a second tire that is simple and inexpensive to manufacture.

STILL ANOTHER OBJECT of the present invention is to provide a device and method for transferring air from a first tire to a second tire that is simple to use.

BRIEFLY STATED, STILL YET ANOTHER OBJECT of the present invention is to provide a device and method for transferring air from a first tire to a second tire which comprises an elongated flexible tube having an air flow passageway therethrough. Two coupling adaptor components are provided, with each attached to a free end of the elongated flexible tube to engage with an air valve of one of the tires. A mechanism in each of the coupling adaptor components is for opening the air valves in one of the tires, to allow air to transfer from the second tire to the first tire that is under inflated, to balance some of the air pressure between the tires.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic perspective view showing an embodiment of the present invention rolled up, so that it is ready to be used in an emergency situation when replacing a flat tire with a spare tire which is under inflated onto a rear left axle of a motor vehicle;

FIG. 2 is an enlarged diagrammatic perspective view of the area enclosed in the dotted circle indicated by arrow 2 in FIG. 1, showing the present invention per se extended and broken away;

FIG. 3 is an enlarged diagrammatic perspective view of the area enclosed in the dotted circle indicated by arrow 3 in FIG. 2, showing the coupling adaptor component in greater detail;

FIG. 4 is an enlarged cross sectional view taken on line 4-4 in FIG. 3;

FIG. 5 is an enlarged cross sectional view showing the coupling adaptor component installed on an air valve of a tire;

FIG. 6 is a diagrammatic top view of the motor vehicle showing the present invention in a first required air transfer mode;

FIG. 7 is a diagrammatic top view of the motor vehicle showing the present invention in a second required air transfer mode; and

FIG. 8 is a diagrammatic top view of the motor vehicle showing the present invention in a third required air transfer mode.

### A MARSHALING OF REFERENCE NUMERALS UTILIZED IN THE DRAWING

10 air transferring device
12 first tire
14 second tire
16 elongated flexible tube of device 10
18 air flow passageway in tube 16
20 coupling adapter component of device 10
22 air valve
24 air valve opening mechanism of device 10
26 collar assembly of component 20
28 internally threaded knurled fitting of component 20
30 externally threaded portion of stem 32
32 stem of air valve 22
34 elongated rod of mechanism 24
36 flat tire
38 first axle on motor vehicle 40
40 motor vehicle
42 third tire
44 second axle on motor vehicle 40
46 fourth tire

### DETAILED DESCRIPTION OF THE PREFERRED EMBODIMENT

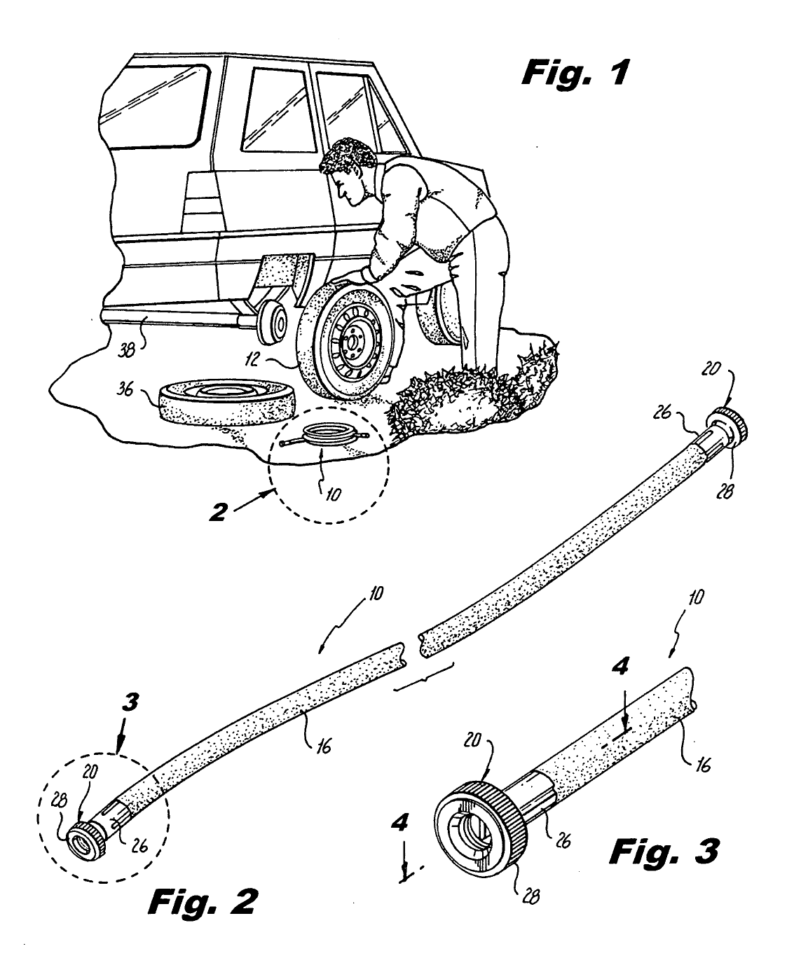

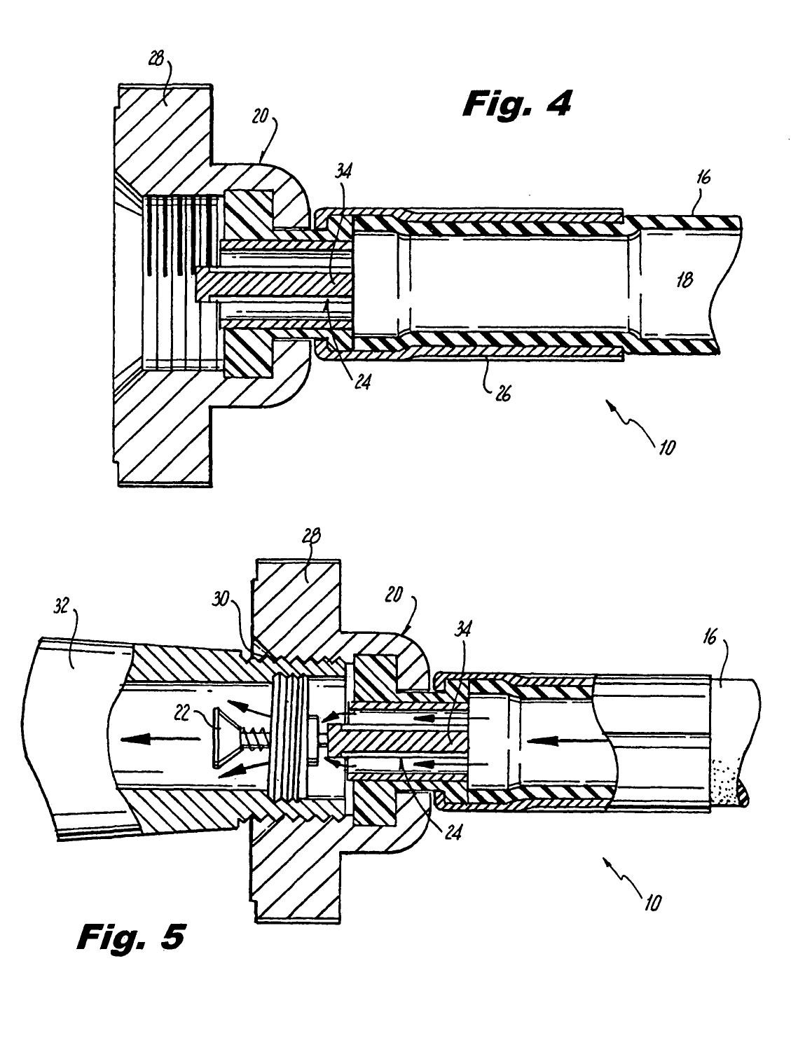

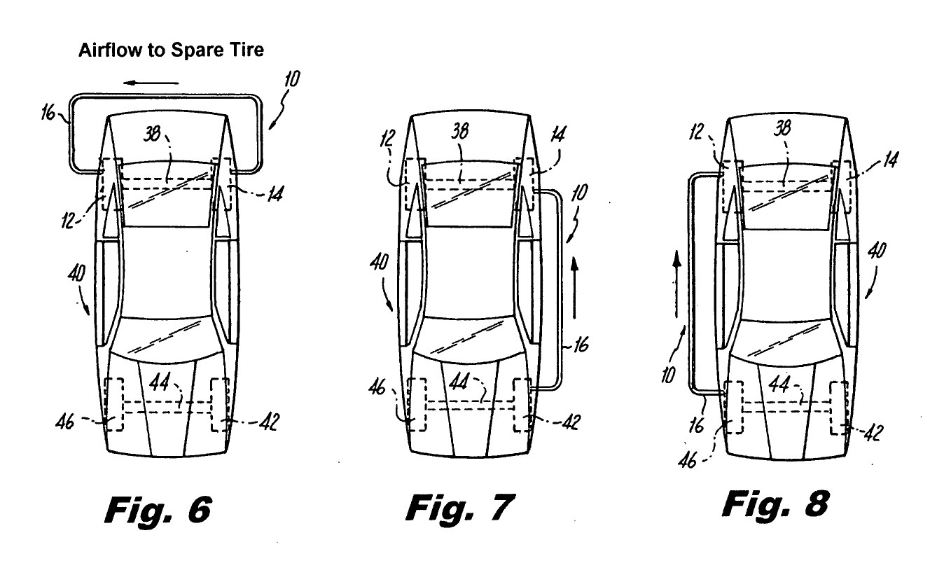

Referring now to the figures, in which like numerals indicate like parts, and particularly to FIGS. 1 through 8, which are a diagrammatic perspective view showing an embodiment of the present invention rolled up, so that it is ready to be used in an emergency situation when replacing a flat tire with a spare tire which is under inflated onto a rear left axle of a motor vehicle; an enlarged diagrammatic perspective view of the area enclosed in the dotted circle indicated by arrow 2 in FIG. 1, showing the present invention per se extended and broken away; an enlarged diagrammatic perspective view of the area enclosed in the dotted circle indicated by arrow 3 in FIG. 2, showing the coupling adaptor component in greater detail; an enlarged cross sectional view taken on line 4-4 in FIG. 3; an enlarged cross sectional view showing the coupling adaptor component installed on an air valve of a tire; a diagrammatic top view of the motor vehicle showing the present invention in a first required air transfer mode; a diagrammatic top view of the motor vehicle showing the present invention in a second required air transfer mode; and a diagrammatic top view of the motor vehicle showing the present invention in a third required air transfer mode, and as such, will be discussed with reference thereto.

The present invention is a device 10 for transferring air from a first tire 12 to a second tire 14 which comprises an elongated flexible tube 16 having an air flow passageway 18 therethrough. Two coupling adaptor components 20 are provided, with each attached to a free end of the elongated flexible tube 16 to engage with an air valve 22 of one of the tires 12, 14. A mechanism 24 in each of the coupling adaptor components 20 is for opening the air valves 22 in one of the tires 12, 14, to allow air to transfer from the second tire 14 to the first tire 12 that is under inflated, to balance some of the air pressure between the tires 12, 14.

Each coupling adaptor component 20 comprises a collar assembly 26 affixed to one free end of the elongated flexible tube 16. An internally threaded knurled fitting 28 is rotatably mounted on the collar assembly 26. The internally threaded knurled fitting 28 will screw onto an externally threaded portion 30 of a stem 32 of the air valve 22.

Each air valve opening mechanism 24 comprises an elongated rod 34 extending forwardly from the collar assembly 26. When the internally threaded knurled fitting 28 is screwed onto the externally threaded portion 30 of the stem 32 of the air valve 22, the elongated rod 34 will depress the air valve 22 to allow the air to flow through the air valve 22.

To transfer air between tires the following steps are illustrative of a typical situation for which there are a great many:
1. Provide the device 10 which includes the elongated flexible tube 16, the two coupling adaptor components 20 and the air valve opening mechanism 24 in each coupling adaptor component 20.
2. Remove a flat tire 36 from a first axle 38 of a motor vehicle;
3. Mount the first tire 12 which is under inflated onto the first axle 38 of the motor vehicle 40.
4. Engage one coupling adaptor component 20 to the air valve 22 of the first tire 12.
5. Engage the other coupling adaptor component 20 to the air valve 22 of the second tire 14 on the first axle 42, wherein the two air valve opening mechanisms 24 will open the two air valves 22 of the first tire 12 and the second tire 14 to allow the transfer of some of the air from the second tire 14 to the first tire 12 that is under deflated, to balance the air pressure there between.
6. Disengage the coupling adaptor component 20 from the air valve 22 of the first tire 12.
7. Engage the coupling adaptor component 20 to an air valve 22 on a third tire 42 on a second axle 44 of the motor vehicle 40 directly opposite from and on the same side of the second tire 14, wherein the two air valve opening mechanisms 24 will open the two air valves 22 on the second tire 14 and the third tire 42 to allow transfer of some of the air from the third tire 42 to the second tire 14 to balance the air pressure there between.
8. Disengage the coupling adaptor component 20 from the air valve 22 on the third tire 42.
9. Disengage the coupling adaptor component 20 from the air valve 22 on the second tire 14.
10. Engage one coupling adaptor component 20 to the air valve 22 on a fourth tire 46 on the second axle 44.
11. Engage the other coupling adaptor component 20 to the air valve 22 on the first tire 12 on the first axle 38, wherein the two valve opening mechanisms 24 will open the two air valves 22 on the first tire 12 and the fourth tire 46 to allow transfer of some of the air from the fourth tire 46 to the first tire 12 to balance the air pressure there between.

It will be understood that each of the elements described above, or two or more together, may also find a useful application in other types of constructions differing from the types described above.

While the invention has been illustrated and described as embodiments of a device and method for transferring air from a first tire to a second tire, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A device and method for transferring air from a first tire to a second tire which comprises:
a) an elongated flexible tube having an air flow passageway therethrough;
b) two coupling adaptor components, each attached to a free end of said elongated flexible tube to engage with an air valve of one of the tires; and
c) means, in each of said coupling adaptor components for opening the air valves in one of the tires to allow air to transfer from the second tire to the first tire that is under inflated, to balance of the air pressure between the tires.

2. The device as recited in claim 1, wherein each said coupling adaptor component comprises:
a) a collar assembly affixed to one free end of said elongated flexible tube; and
b) an internally threaded knurled fitting rotatably mounted on said collar assembly, wherein said internally threaded knurled fitting will screw onto an externally threaded portion of a stem of the air valve.

3. The device as recited in claim 2, wherein each said air valve opening means comprises an elongated rod extending forwardly from said collar assembly, so that when said internally threaded knurled fitting is screwed onto the externally threaded portion of the stem of the air valve, said elongated rod will depress the air valve to allow the air to flow through the air valve.

4. A method for transferring air between tires comprising the steps of:
a) providing a device which includes an elongated flexible tube, two coupling adaptor components and an air valve opening means in each coupling adaptor component;
b) removing a flat tire from a first axle of a motor vehicle;
c) mounting a first tire which is under inflated onto the first axle of the motor vehicle;
d) engaging one coupling adaptor component to an air valve of the first tire; and
e) engaging the other coupling adaptor component to an air valve of a second tire on the first axle, wherein the two air valve opening means will open the two air valves of the first tire and the second tire to allow the transfer of some of the air from the second tire to the first tire that is under inflated to balance the air pressure there between.

5. The method as recited in claim 4, further comprising the steps of:
a) disengaging the coupling adaptor component from the air valve of the first tire; and
b) engaging the coupling adaptor component to an air valve on a third tire on a second axle of the motor vehicle directly opposite from and on the same side of the second tire, wherein the two air valve opening means will open the two air valves on the second tire and the third tire to allow transfer of some of the air from the third tire to the second tire to balance the air pressure there between.

6. The method as recited in claim 5, further comprising the steps of:
a) disengaging the coupling adaptor component from the air valve on the third tire;
b) disengaging the coupling adaptor component from the air valve on the second tire;
c) engaging one coupling adaptor component to the air valve on a fourth tire on the second axle; and
d) engaging the other coupling adaptor component to the air valve on the first tire on the first axle, wherein the two valve opening means will open the two air valves on the first tire and the fourth tire to allow transfer of some of the air from the fourth tire to the first tire to balance the air pressure there between.
